(19) United States
(12) Patent Application Publication
(10) Pub. No.: US 2006/0095875 A1
(43) Pub. Date: May 4, 2006

(54) Design method of semiconductor integrated circuit

(75) Inventors: Kei Mohara, Isesaki (JP); Yasuyoshi Noguchi, Fujioka (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 11/262,814

(22) Filed: Nov. 1, 2005

(30) Foreign Application Priority Data
Nov. 2, 2004 (JP) 2004-319340

(51) Int. Cl. G06F 17/50

(52) U.S. Cl. 716/2

(57) ABSTRACT

General-purpose software is used to efficiently perform sample evaluation in a short period of time by changing a register library in accordance with register configuration of a semiconductor integrated circuit device. A register setup program is used for sample evaluation and is composed of a register setup main program and register libraries. The register setup main program has a product-independent standard function concerning register control and is provided as a general-purpose program congruous with all semiconductor integrated circuit devices targeted for the sample evaluation. The register libraries contain a word that indicates an address for specifying a specific register and data to be contained in the register. The register libraries are provided for a semiconductor integrated circuit device on a product basis. The evaluation uses the general-purpose register setup main program and a given separate register library.

### CROSS-REFERENCE TO RELATED APPLICATION

The present application claims priority from Japanese patent application No. 2004-319340 filed on Nov. 2, 2004, the content of which is hereby incorporated by reference into this application.

### BACKGROUND OF THE INVENTION

The present invention relates to a technology of sample evaluation for a semiconductor integrated circuit device and particularly to a technology effectively applicable to sample evaluation of a semiconductor integrated circuit device through the use of software.

A semiconductor integrated circuit device for RF (radio frequency) processing is widely used for cellular phones, one of mobile communication systems, and represents a semiconductor integrated circuit device mixedly composed of analog and digital components. While there is an increasing demand for product versatility and shortening of the development period, it is becoming important to provide customers with the semiconductor integrated circuit device as early as possible.

As an example of evaluating experimental manufacture (sample) of the semiconductor integrated circuit device, there is available a technology that uses the evaluation software to generate test signals from a personal computer, for example. The technology maps the test signals to various registers constituting a logic portion of the semiconductor integrated circuit device and changes the logic portion to various states. There is further provided a technology to read information stored in the semiconductor integrated circuit device.

### SUMMARY OF THE INVENTION

The inventors found the following problems in the above-mentioned software-based sample evaluation technology for semiconductor integrated circuit devices.

Types of semiconductor integrated circuit devices use different register specification and the like. Accordingly, a single set of evaluation software cannot be used for multiple types of semiconductor integrated circuit devices in a general-purpose manner.

A new special program (evaluation program) needs to be developed for each type of semiconductor integrated circuit devices. The development period for the program is prolonged. In addition, costs also increase.

During the development of a semiconductor integrated circuit device, for example, a customer's request may cause changes in the circuit and the register specification. When the developed special program is modified accordingly, new steps may be needed to modify the program. It may be impossible to fast respond to the program design request.

There may be a case where multiple programs are requested to be developed at the same time. In such case, it may be necessary to determine development priorities for the corresponding types of semiconductor integrated circuit devices and develop the programs for these types of circuits. When a program needs to be modified, for example, it may be impossible to fast reflect the program modification on the multiple types of semiconductor integrated circuit devices.

It is an object of the present invention to provide a technology capable of efficiently evaluating semiconductor integrated circuit device samples in a short period of time at low cost by changing and selecting register libraries and combining basic software with register libraries so as to be compliant with configurations and functions of various control registers provided for the semiconductor integrated circuit device.

The above and further objects and novel features of the invention will more fully appear from the following detailed description when the same is read in connection with the accompanying drawing.

The following concisely describes representative overviews of the invention disclosed in the application.

A design method for a semiconductor integrated circuit device according to the present invention a register setup program body as a general-purpose program which has a product-independent standard function concerning register control and is compliant with all semiconductor integrated circuit devices targeted for sample evaluation; and plural register libraries including data provided to be suited for register configurations compliant with respective semiconductor integrated circuit device products. The register library has at least word information indicating an address to specify a given register in the semiconductor integrated circuit device and data stored in the register on a product basis. Sample evaluation is performed for the semiconductor integrated circuit device by selecting a register library which belongs to the plural register libraries and corresponds to register configuration of the semiconductor integrated circuit device targeted for the sample evaluation. The word information stored in the register library is to be stored in a control register provided for a given semiconductor integrated circuit device, for example.

The following describes concisely describes the other overviews of the present invention in the application.

Conforming with the design method for a semiconductor integrated circuit device according to the present invention, the register library stores a bit length of the word information.

Conforming with the design method for a semiconductor integrated circuit device according to the present invention, the register setup program body has a GUI control function to display GUI parts and register maps. The register library has GUI information for changing configuration and appearance of a GUI-based operation function displayed by the GUI control function. The GUI-displayed operation function is used to change the ward information.

Conforming with the design method for a semiconductor integrated circuit device according to the present invention, the register library has serial communication pattern information that is an output pattern of serial signals to be output to the semiconductor integrated circuit device. The serial communication pattern information provides an output pattern to be output to the semiconductor integrated circuit device by converting the word information into a communication pattern of serial signals. The register setup program converts the word information about a product targeted for the sample evaluation into a serial signal based on the serial communication pattern information.

Conforming with the design method for a semiconductor integrated circuit device according to the present invention, the serial communication pattern information includes information about assignment of transmission and reception terminals for a communication interface when outputting the communication pattern of serial signals. The register setup program can output the word information converted into a serial signal to the semiconductor integrated circuit device based on information about assignment of transmission and reception terminals.

Conforming with the design method for a semiconductor integrated circuit device according to the present invention, the register library has a data association function to associate the data. When word information for a given register is changed to a given setup condition, the data association function automatically changes the word information for all registers associated with the given register based on association information so as to be associated with the given register's setup condition.

The following describes representative effects of the invention disclosed in the application.

(1) The register library contains information about each product to be designed. Changing or selecting the register library makes it possible to easily perform the sample evaluation for different semiconductor integrated circuit device products without changing the register setup program to be combined with the register library. This can greatly reduce program development costs for the sample evaluation and shorten the development period.

(2) It is possible to fast and flexibly deal with changes, if any, in a circuit or the register specification of the semiconductor integrated circuit device simply by changing or selecting information in the register library specific to the product.

(3) The above-mentioned effects (1) and (2) make it possible to improve reliability of the semiconductor integrated circuit device and reduce costs thereof.

### BRIEF DESCRIPTION OF THE DRAWINGS

FIG. 1 illustrates a sample evaluation system according to an embodiment of the present invention;

FIG. 2 exemplifies the program configuration of a register setup program installed in a host constituting the sample evaluation system in FIG. 1;

FIG. 3 exemplifies the contents of register libraries provided for the register setup program in FIG. 2;

FIG. 4 shows register map information constituting the register library in FIG. 3;

FIG. 5 is a signal timing chart showing an example of writing serial communication pattern information constituting the register library in FIG. 3;

FIG. 6 is a signal timing chart showing an example of reading serial communication pattern information constituting the register library in FIG. 3;

FIG. 7 exemplifies transmission and reception pin information constituting the register library in FIG. 3;

FIG. 8 shows display examples of GUI screens for different products displayed on a host monitor provided for the sample evaluation system in FIG. 1; and

FIG. 9 is a flowchart exemplifying a process of the register setup program performed by the sample evaluation system in FIG. 1.

### DETAILED DESCRIPTION OF THE PREFERRED EMBODIMENTS

Embodiments of the present invention will be described in further detail with reference to the accompanying drawings. Throughout all the drawings that describe the embodiments, the same members when shown in more than one figure are designated by the same reference numerals and a repetitive description is omitted.

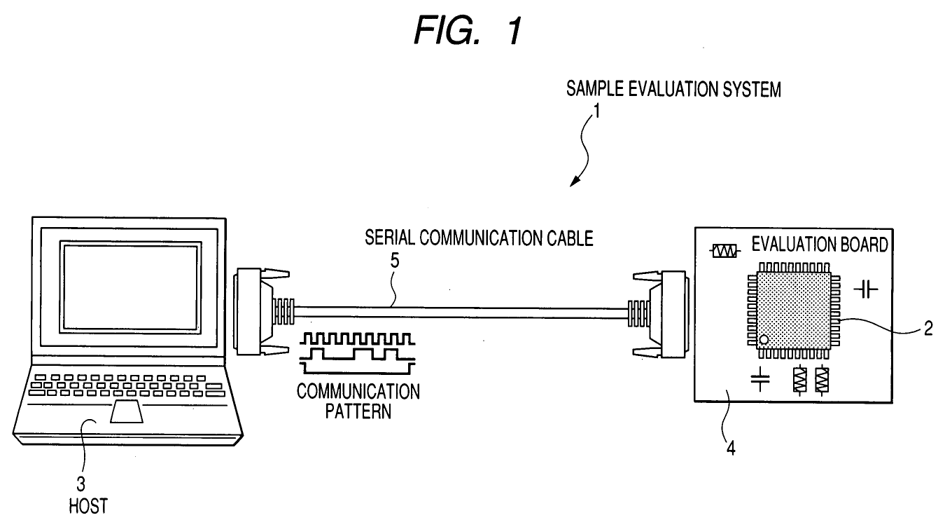

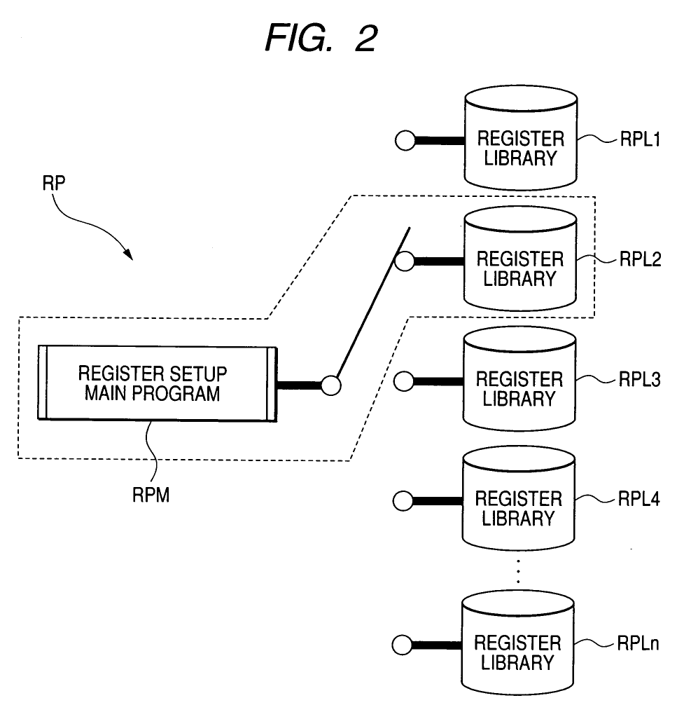

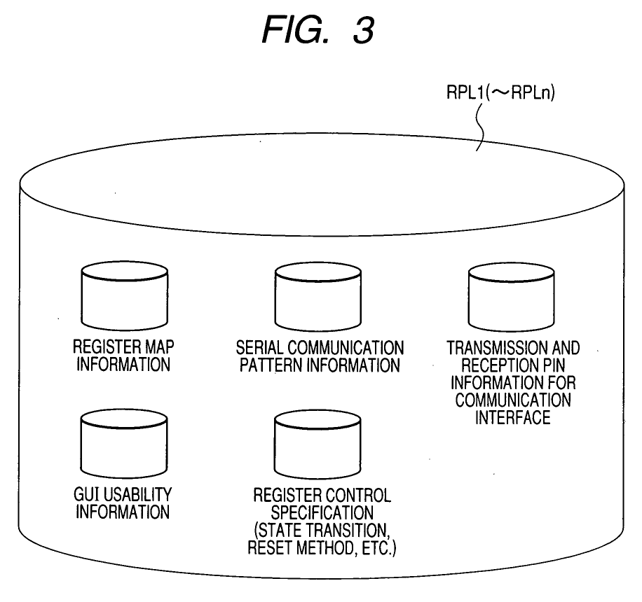

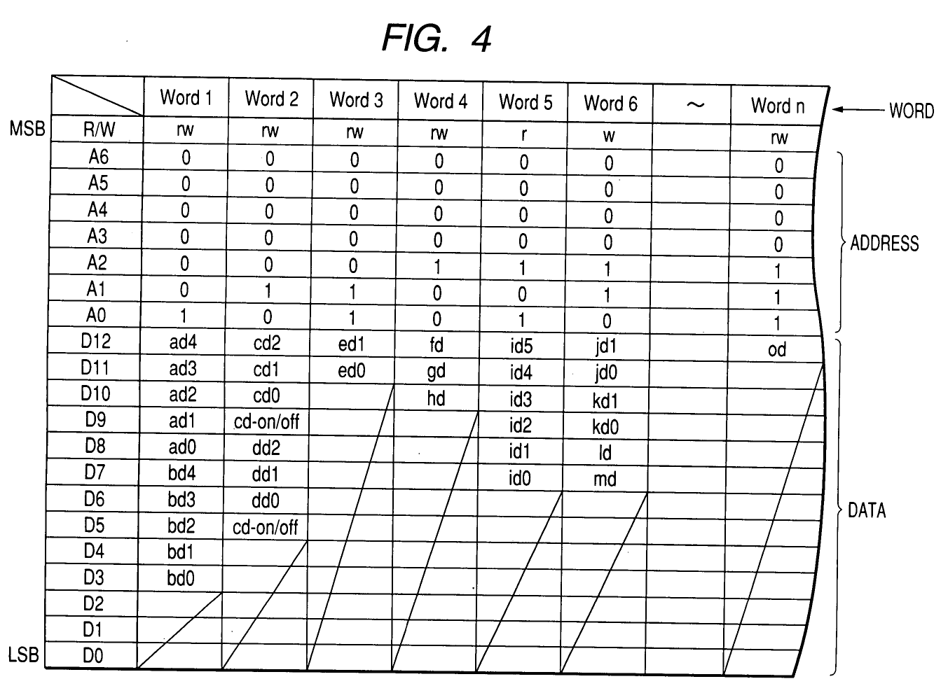

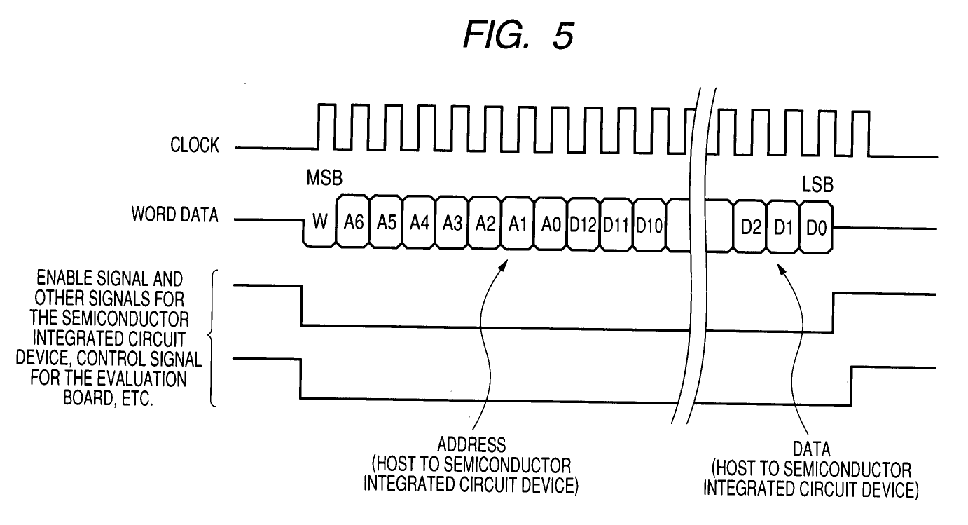

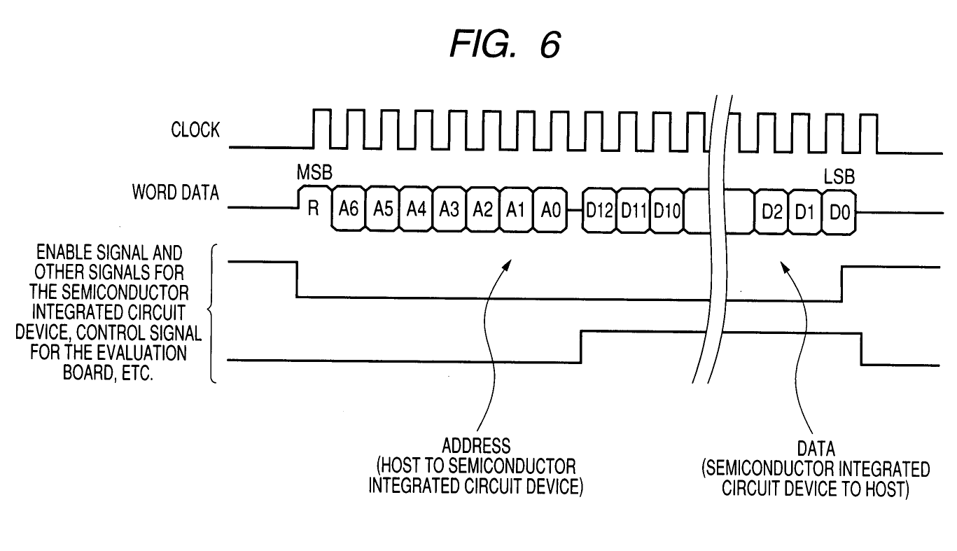

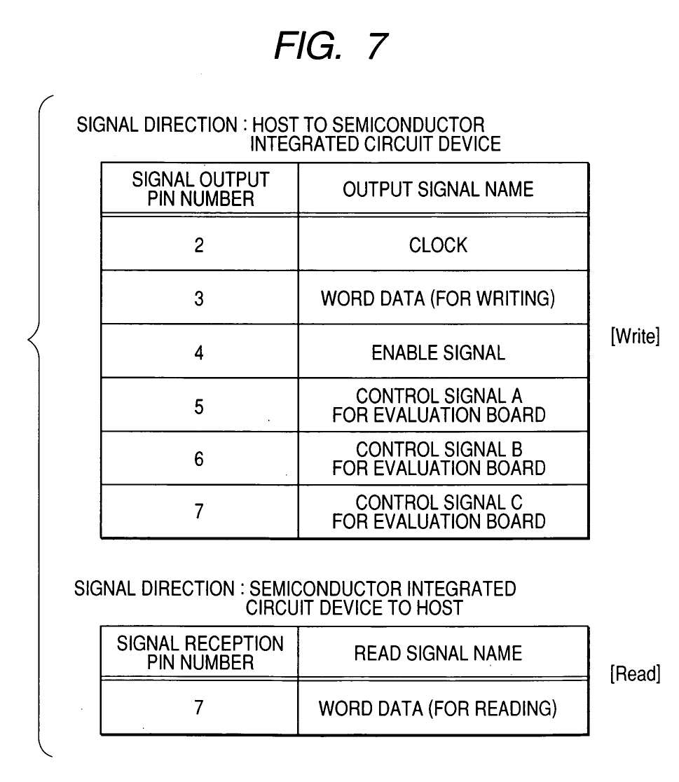

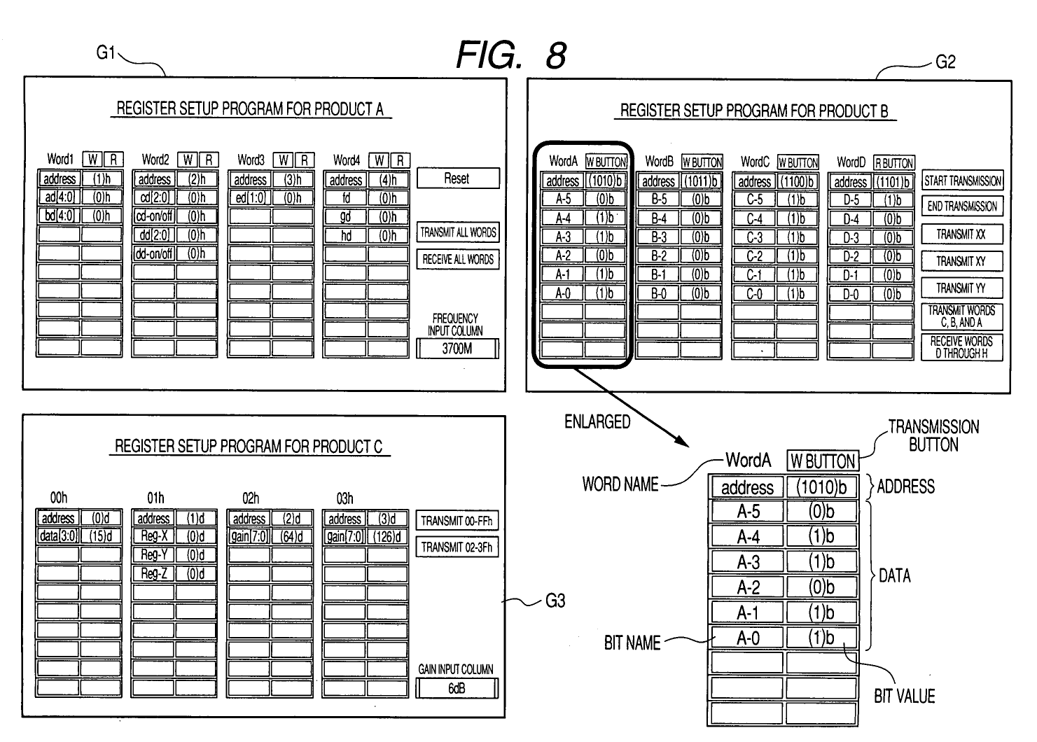

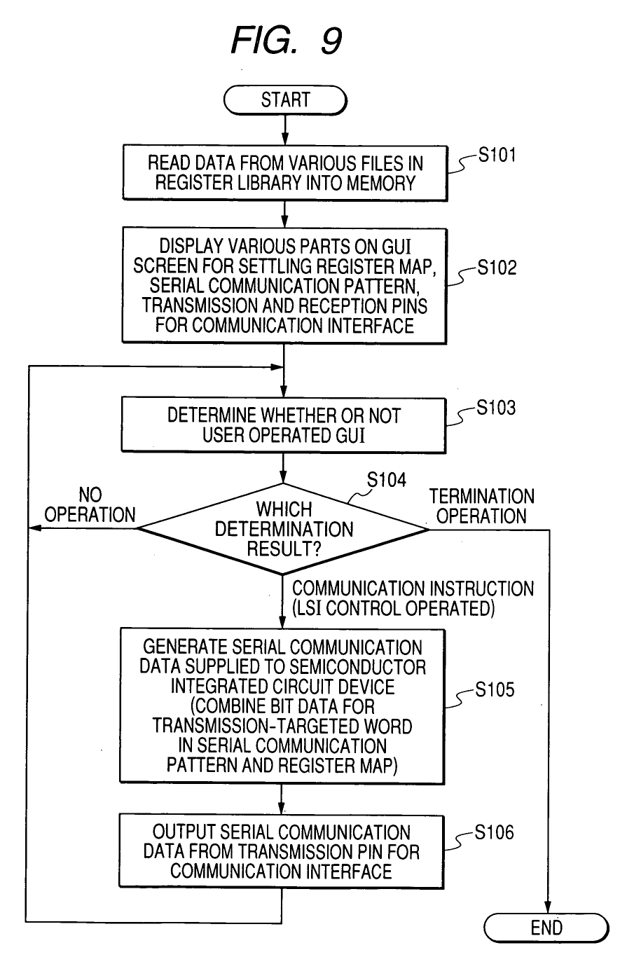

FIG. 1 illustrates a sample evaluation system according to an embodiment of the present invention. FIG. 2 exemplifies the program configuration of a register setup program installed in a host constituting the sample evaluation system in FIG. 1. FIG. 3 exemplifies the contents of register libraries provided for the register setup program in FIG. 2. FIG. 4 shows register map information constituting the register library in FIG. 3. FIG. 5 is a signal timing chart showing an example of writing serial communication pattern information constituting the register library in FIG. 3. FIG. 6 is a signal timing chart showing an example of reading serial communication pattern information constituting the register library in FIG. 3. FIG. 7 exemplifies transmission and reception pin information constituting the register library in FIG. 3. FIG. 8 shows display examples of GUI screens for different products displayed on a host monitor provided for the sample evaluation system in FIG. 1. FIG. 9 is a flowchart exemplifying a process of the register setup program performed by the sample evaluation system in FIG. 1.

A sample evaluation system 1 according to the embodiment performs sample evaluation for a semiconductor integrated circuit device 2 mixedly composed of analog and digital components, for example. As shown in FIG. 1, the sample evaluation system 1 is composed of a host 3 such as a personal computer and an evaluation board 4.

The host 3 and the evaluation board 4 are connected to each other via a serial communication cable 5, for example. The host 3 has its communication interface (e.g., a printer port) to connect with the serial communication cable 5. Any interface other than the printer port may be used for connection between the serial communication cable 5 and the host 3. It may be preferable to use an interface that has the specified number of terminals (e.g., three terminals or more) needed for data communication with the semiconductor integrated circuit device and is capable of outputting serial signals.

The host 3 and the evaluation board may be connected via a communication interface that can output not only serial signals, but also parallel signals. Further, it may be preferable to transmit data to the semiconductor integrated circuit device using a USB interface and wireless communication. It may be preferable to use any general-purpose interface that can send and receive data needed for the sample evaluation.

A register setup program RP (FIG. 2) is installed in the host 3 for sample evaluation of the semiconductor integrated circuit device 2 mounted on the evaluation board 4.

The register setup program RP generates various communication patterns and writes word (FIG. 4) data to various registers constituting the logic portion of the semiconductor integrated circuit device 2 for mapping. In this manner, the register setup program RP performs the sample evaluation. In addition, during the evaluation, the register setup program RP can also allow the host 3 to read information assigned to the registers and information stored in the semiconductor integrated circuit device as needed.

FIG. 2 exemplifies the program configuration of the register setup program RP.

As shown in FIG. 2, the register setup program RP is composed of a register setup main program (register setup program core) RPM and register libraries RPL1 through RPLn provided for products (types) of the semiconductor integrated circuit device 2.

The register setup main program RPM has a product-independent standard function concerning the register control. The register setup main program RPM works as a general-purpose program for all semiconductor integrated circuit devices targeted for the sample evaluation.

Functions of the register setup main program RPM include, for example, GUI control (GUI control function), security control, communication control, and platform control over the register libraries RPL1 through RPLn, register library reading, register library definition, compliance with the semiconductor integrated circuit device, and compliance with an automatic measuring program.

The register libraries RPL1 through RPLn may be provided with a protection function that prevents the third party such as users from rewriting at least the register map information out of the other information constituting the register libraries RPL1 through RPLn. This function can prevent the register libraries RPL1 through RPLn from being tampered or rewritten, improving the security. The protection function can also prevent products' malfunctions that may result from falsifying the register libraries and changing values to be specified for various controls registers.

The GUI control function displays GUI parts and a register map. The GUI control includes many pieces of display information needed for the sample evaluation such as multiple registers having the specified number of bits, a control button defined for communication control with an evaluation board, and character information needed for various controls.

The security function for register libraries protects the register libraries and the register map.

The communication control function converts word data (word information) into a serial signal according to the serial communication pattern control included in the register libraries. The communication control function also transmits word data converted into the serial signal, receives register information from the semiconductor integrated circuit device, and analyzes transmission and reception data.

The platform control function relates to various OS's (Operating Systems) in the host 3.

The register library reading function reads a register library data file into memory provided for the host 3 and analyzes library data description.

The register library definition function defines serial communication patterns, transmission and reception for the printer port (communication interface), the communication interface and addresses for the host 3, and GUI usability.

The semiconductor integrated circuit device compliance function records a history of changing or setting register control operations (register macro recording) and reexecutes register control operations according to the history of settings and changes (register macro execution).

FIG. 3 exemplifies the contents of the register library RPL1 (through RPLn).

The register libraries RPL1 through RPLn provide data suited for the register configuration of a semiconductor integrated circuit device targeted for each product. The register library RPL1 (through RPLn) includes register map information, serial communication pattern information, transmission and reception pin information, GUI usability information (GUI information), and register control specification. In addition to these pieces of information, product-specific control data may be provided as needed.

As shown in FIG. 4, the register map information is composed of multiple words (Word1 through Wordn) corresponding to registers of the target semiconductor integrated circuit device. A word represents: address information specifying a specific register; and data stored in the register.

In each word of FIG. 4, bit RW (starting bit) indicates a write (w) or read (r) operation. Bits A6 through A0 indicate a register address. Bits D12 through D0 indicate data stored in the register. Depending on needs, it may be preferable to be capable of transmitting initial data to be assigned to each control register.

The serial communication pattern information is written to the semiconductor integrated circuit device 2 from the host 3 or is read from the semiconductor integrated circuit device 2 to the host 3. For example, the serial communication pattern information includes a clock signal, word (FIG. 4) data, a control signal such as a chip enable signal for the semiconductor integrated circuit device 2, and a control signal for the evaluation board 4. In addition, the serial communication pattern information includes a signal's initial or termination level, a register's latch timing (rise or fall of the clock signal), the variable or fixed bit length for a word, and bit positions for addresses and data.

The serial communication pattern information is used to convert various signals according to the communication control included in the register setup main program RPM for data communication between the host 3 and the semiconductor integrated circuit device.

FIG. 5 is a signal timing chart showing an example of writing the serial communication pattern information from the host 3 to the semiconductor integrated circuit device 2. FIG. 6 is a signal timing chart showing an example of reading the serial communication pattern information.

In FIGS. 5 and 6, the timing chart represents a clock signal, word data, and the other control signals from the top to the bottom.

During writing in FIG. 5, the word data becomes a Lo (0) level signal whose starting bit indicates the write operation. Thereafter, the host 3 sequentially outputs an address and data to the semiconductor integrated circuit device 2.

During reading in FIG. 6, the word data becomes a Hi (1) level signal whose starting bit indicates the read operation. An address is then output to the semiconductor integrated circuit device 2. Subsequently, the semiconductor integrated circuit device 2 outputs register data corresponding to the input address to the host 3.

The host 3 converts a pattern of signals to be transmitted to the semiconductor integrated circuit device according to the serial communication pattern information included in the register library. It is possible to variously select combinations of signals to be transmitted according to the serial communication pattern information.

FIG. 7 exemplifies the transmission and reception pin information. An upper part of FIG. 7 shows the transmission and reception pin information during writing. A lower part of FIG. 7 shows the transmission and reception pin information during reading.

As shown in FIG. 7, the transmission and reception pin information includes signal output pin numbers and output signal names during writing and signal reception pin numbers and read signal names during reading. During writing, the host 3 outputs the signal output pin numbers to the semiconductor integrated circuit device 2. The output signal name indicates the type of output signal.

The signal reception pin number indicates the pin number for the signal that is output from the semiconductor integrated circuit device 2 and is received by the host 3 during reading. The read signal name indicates the type of signal read from the semiconductor integrated circuit device 2.

During writing, for example, pin 4 of the communication interface for the host 3 outputs an enable signal to the semiconductor integrated circuit device 2. During reading, pin 7 of the communication interface for the host 3 inputs word data from the semiconductor integrated circuit device 2.

The GUI usability information is used to change configurations and displays of an operation function displayed on a monitor of the host 3. The GUI usability information includes a data association function.

The data association function specifies a given bit for an associated register based on a specific equation and automatically changes the register's value.

For example, there may be a semiconductor integrated circuit device for high-frequency processing to operate at multiple frequencies (channels). When such semiconductor integrated circuit device is confirmed whether or not to operate for each of the channels, it is necessary to change the reference frequency corresponding to the channel.

In this case, when the first condition is specified for a specific bit in a given register, bits in the associated registers are automatically changed so that all the other associated registers follow the first condition.

Likewise, when the second condition is specified for a specific bit in a given register, bits in the associated registers are automatically changed so that all the other associated registers follow the second condition.

FIG. 8 shows examples of product-based GUI screens G1 through G3 displayed on a monitor of the host 3.

In this case, the GUI screens G1 through G3 correspond to the register table in FIG. 4. For example, the GUI screen G2 displays setup information for words A through D from left to right. The right end of the screen shows function keys allocated to optimize the usability of each product.

The GUI screen G1 is especially provided with a “frequency input column” to set frequencies used for the high-frequency processing semiconductor integrated circuit device.

The bottom right of FIG. 8 shows an enlarged view of the setup information about word A on the GUI screen G2.

As shown in FIG. 8, the word setup information contains the word name at the upper left. To its right, a W button (transmission button) is disposed to transmit word data to the semiconductor integrated circuit device from the host 3.

Below the word name and the W button, there are displayed address information, bit names, and data (bit values). The address information specifies a register to be placed in the semiconductor integrated circuit device. The bit names indicate multiple bit functions contained in the word. The data (bit values) is stored in each register.

The GUI-displayed information can be easily changed in accordance with the register map information stored in the register library and the GUI usability information. For example, it is possible to easily change the display control of the input column in a word, functions allocated to the function keys, and the display control of the function key buttons.

The register control specification provides information about specifications such as the state control and the reset method for the semiconductor integrated circuit device 2 corresponding to each product. For example, the register control specification controls a transmission sequence of word data to be transmitted to the registers.

The register libraries RPL1 through RPLn include the register map information, the serial communication pattern information, the transmission and reception pin information, the GUI usability information, and the register control specification. In addition, the register libraries RPL1 through RPLn may include the other information such as help information describing output pin names and functions for the communication interface depending on needs.

A flowchart in FIG. 9 is used to describe the process of the register setup program RP performed by the sample evaluation system 1 according to the embodiment.

FIG. 9 shows the flowchart describing that the host 3 writes serial communication data to the semiconductor integrated circuit device 2 using the communication control and the serial communication pattern information.

First, a semiconductor integrated circuit device is specified as a product targeted for the sample evaluation. The register setup program RP installed in the host 3 starts to read data into memory of the host 3 from the register library (e.g., register library RPL1). This register library is stored in a hard disk, for example, of the host 3 and corresponds to the specified semiconductor integrated circuit device (Step S101).

In this example, the register setup program RP starts to read the predetermined register library RPL1. The host 3 can be constructed to change any register library to be preread when the register setup program RP starts.

Based on the read register library RPL1, the host 3 settles a register map, a serial communication pattern, and transmission and reception pins for the communication interface. The host 3 allows the monitor to display the GUI screen (FIG. 8) of the corresponding semiconductor integrated circuit device (Step S102).

A user then operates the GUI screen to change data stored in the word data as needed and issue a transmission instruction such as “Transmit all words” (Steps S103 and S104). The host 3 combines the serial communication pattern information with the register map information in the register library to generate serial communication data (Step S105). The host 3 outputs the serial communication data from its communication interface to the semiconductor integrated circuit device 2 (Step S106).

The following describes how to distribute the register setup program RP to users.

The register setup program RP is recorded on recording media such as CD-ROM (Compact Disc-Read Only Memory), DVD-ROM (Digital Versatile Disc-ROM), and DVD-RAM (DVD-Random Access Memory) for distribution.

For example, these recording media store the register setup program RP in any of the following combinations: the register setup main program RPM and the register library for the corresponding semiconductor integrated circuit device as a product; the register setup main program RPM, the register libraries RPL1 through RPLn, and the register setup program specific to the product; and the register setup main program RPM and the register libraries RPL1 through RPLn.

The recording medium is distributed to a user as one distribution unit so as to store the register setup program RP according to any one of the combinations. In this manner, the register setup program RP can be used for the development of semiconductor integrated circuit devices according to an optimal combination.

The register setup program RP can also be distributed via communication lines such as the Internet, for example, in addition to the distribution by means of recording media. In this manner, the register can be easily developed for each targeted product.

According to the embodiment, simply changing the register libraries RPL1 through RPLn can easily perform the sample evaluation of the semiconductor integrated circuit device 2. This can greatly reduce program development costs and shorten the development period. Further, it is possible to flexibly deal with changes in a circuit or the register specification of the semiconductor integrated circuit device.

While there has been described the specific preferred embodiment of the present invention made by the inventors, it is to be distinctly understood that the present invention is not limited thereto but may be otherwise variously embodied within the spirit and scope of the invention.

The present invention provides a technology capable of efficiently performing the sample evaluation of a product-based semiconductor integrated circuit device in accordance with the register configuration of the same in a short period of time at low cost by using general-purpose software.

What is claimed is:

1. A design method for a semiconductor integrated circuit device comprising:
a register setup program body as a general-purpose program which has a product-independent standard function concerning register control and is compliant with all semiconductor integrated circuit devices targeted for sample evaluation; and
a plurality of register libraries including data provided to be suited for register configurations compliant with respective semiconductor integrated circuit device products,
wherein the register library has at least word information indicating an address to specify a given register in the semiconductor integrated circuit device and data stored in the register on a product basis, and
wherein sample evaluation is performed for the semiconductor integrated circuit device by selecting a register library which belongs to the plurality of register libraries and corresponds to register configuration of the semiconductor integrated circuit device targeted for the sample evaluation.

2. The design method for a semiconductor integrated circuit device according to claim 1,
wherein the register library stores a bit length of the word information.

3. The design method for a semiconductor integrated circuit device according to claim 1,
wherein the register setup program body has a GUI control function to display GUI parts and register maps,
wherein the register library has GUI information for changing configuration and appearance of a GUI-based operation function displayed by the GUI control function, and
wherein the GUI-displayed operation function is used to change the ward information.

4. The design method for a semiconductor integrated circuit device according to claim 1,
wherein the register library has serial communication pattern information output from a serial signal, and
wherein the serial communication pattern information is output by converting the word information into a communication pattern of serial signals.

5. The design method for a semiconductor integrated circuit device according to claim 4,
wherein the serial communication pattern information includes information about assignment of transmission and reception terminals for a communication interface when outputting the communication pattern of serial signals.

6. The design method for a semiconductor integrated circuit device according to claim 1,
wherein the register library has a data association function to associate the data, and
wherein, when word information for a given register is changed to a given setup condition, the data association function automatically changes data included in word information for all registers associated with the given register based on the data association information so as to be associated with the given register's setup condition.
